(19) United States
(12) Patent Application Publication
(10) Pub. No.: US 2024/0332487 A1
(43) Pub. Date: Oct. 3, 2024

(54) SECONDARY BATTERY POSITIVE ELECTRODE INCLUDING FERROELECTRIC COMPONENT AND METHOD OF MANUFACTURING THE SAME

(71) Applicants: Hyundai Motor Company, Seoul (KR); Kia Corporation, Seoul (KR)

(72) Inventor: Jun Ki Rhee, Seoul (KR)

(21) Appl. No.: 18/741,886

(22) Filed: Jun. 13, 2024

Related U.S. Application Data
(62) Division of application No. 17/336,871, filed on Jun. 2, 2021.

(30) Foreign Application Priority Data
Nov. 11, 2020 (KR) 10-2020-0149952

(51) Int. Cl. H01M 4/04; H01M 4/02; H01M 4/131; H01M 4/134; H01M 4/1391; H01M 4/1395; H01M 10/0525

(52) U.S. Cl. CPC H01M 4/0416; H01M 4/131; H01M 4/134; H01M 4/1391; H01M 4/1395; H01M 10/0525; H01M 2004/028

(57) ABSTRACT

Disclosed are a secondary battery positive electrode including a ferroelectric component and a method of manufacturing the same. The method of manufacturing the secondary battery positive electrode may use a low-priced material as the ferroelectric, so process efficiency may be improved. In addition, the secondary battery positive electrode includes the ferroelectric, such that the output performance of a secondary battery including the same may be improved while increasing the capacity at a high charge rate of the secondary battery.

### CROSS-REFERENCE TO RELATED APPLICATION

This application claims, under 35 U.S.C. § 119 (a), the benefit of priority to Korean Patent Application No. 10-2020-0149952 filed on Nov. 11, 2020, the entire contents of which are incorporated herein by reference.

### TECHNICAL FIELD

The present invention relates to a secondary battery positive electrode including a ferroelectric, thereby improving the output performance of a secondary battery while increasing the capacity at a high charge rate of the secondary battery.

### BACKGROUND

A secondary battery is used as a large-capacity power storage battery for electric vehicles or battery power storage systems and as a small high-performance energy source for portable electronic devices, such as mobile phones, camcorders, and laptop computers. Demand for a small high-capacity secondary battery has increased as research on lightweight and low power consumption of parts of portable electronic devices has been conducted in order to miniaturize the portable electronic devices and to use the portable electronic devices for a long time.

A lithium ion battery, as a secondary battery, has greater energy density and greater capacity per unit area than a nickel manganese battery or a nickel cadmium battery. In addition, the lithium ion battery has a low self-discharge rate and a long lifespan. Furthermore, the lithium ion battery has no memory effect, whereby the lithium ion battery has characteristics of convenience in use and a long lifespan.

However, there is a need to improve the output performance of a secondary battery while increasing the capacity at a high charge rate of the secondary battery.

The above information disclosed in this Background section is provided only for enhancement of understanding of the background of the invention and therefore it may contain information that does not form the prior art that is already known in this country to a person of ordinary skill in the art.

### SUMMARY

In preferred aspects, provided is a secondary battery positive electrode including a ferroelectric component and a method of manufacturing the same.

The objects of the present invention are not limited to those described above. The objects of the present invention will be clearly understood from the following description and could be implemented by means defined in the claims and a combination thereof.

In an aspect, provided is a secondary battery positive electrode including a ferroelectric component, a positive electrode active material, a binder, and a conductive agent. Preferably, the ferroelectric component may suitably have a particle size of about 100 nm to 5 μm.

The term “ferroelectric component” or “ferroelectric material” as used herein refers to a substance or material having a spontaneous electric polarization that may be responsive to an external electric field, or be reversed in application of the electric field. The ferroelectric material generally includes crystalline compounds characteristics as chemical purity, phase homogeneity, and size and shape of the particles for spontaneous polarization.

The content of the ferroelectric component may be about 1 to 10 wt % based on 100 wt % of the positive electrode.

The ferroelectric component may include one or more selected from the group consisting of BaTiO₃, (Ba, Sr)TiO₃, PbTiO₃, LiNbO₃, Pb(Zr, Ti)O₃, SrBi₂Ti₂O₉, and amorphous V₂O₅.

The positive electrode active material may include one or more selected from the group consisting of LiMn₂O₄, LiCoO₂, LiNiO₂, LiNiCoMnO₂, LiFeO₄, and LiMnCoNi₃O₂.

In another aspect, provided is a method of manufacturing a secondary battery positive electrode. The method may include steps of: preparing an admixture including a ferroelectric component and a first solvent, preparing a positive electrode slurry including an active material, a binder, a conductive agent, and a second solvent, preparing a coating slurry including the admixture and the positive electrode slurry, applying the coating slurry to a substrate, and drying the applied coating slurry.

The admixture may be prepared by performing ultrasonic dispersion for about 7 to 15 minutes.

The coating slurry may be manufactured through mixing for about 7 to 15 minutes.

The drying may be performed at a temperature of about 75 to 95° C.

Further provided is a secondary battery including the positive electrode. Preferably, the secondary battery may have a capacity of about 120 to 180 mAh/g at about 2 to 5C.

Other aspects of the invention are discussed infra.

### BRIEF DESCRIPTION OF THE DRAWINGS

The above and other features of the present invention will now be described in detail with reference to preferred exemplary embodiments thereof illustrated in the accompanying drawings which are given hereinbelow by way of illustration only, and thus are not limitative of the present invention, and wherein:

FIG. 1 shows an exemplary method of manufacturing a secondary battery positive electrode according to an exemplary embodiment of the present invention;

FIG. 2 is a graph showing cycle-based capacities of secondary batteries manufactured according to Examples 1 to 4 and Comparative Example 1;

FIG. 3 is a graph showing cycle-based capacities at high charge rates of the secondary batteries manufactured according to Examples 1 to 4 and Comparative Example 1; and

FIG. 4 is a graph showing the results of XRD analysis of secondary batteries manufactured according to Example 1 and Comparative Example 2 based on particle size of a ferroelectric component included therein.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes, will be determined in part by the particular intended application and use environment.

In the figures, reference numbers refer to the same or equivalent parts of the present invention throughout the several figures of the drawing.

### DETAILED DESCRIPTION

The objects described above, and other objects, features and advantages will be clearly understood from the following preferred embodiments with reference to the attached drawings. However, the present invention is not limited to the embodiments and will be embodied in different forms. The exemplary embodiments are suggested only to offer thorough and complete understanding of the disclosed contents and sufficiently inform those skilled in the art of the technical concept of the present invention.

It will be further understood that the terms “comprises”, “has” and the like, when used in this specification, specify the presence of stated features, numbers, steps, operations, elements, components or combinations thereof, but do not preclude the presence or addition of one or more other features, numbers, steps, operations, elements, components, or combinations thereof. In addition, it will be understood that, when an element such as a layer, film, region or substrate is referred to as being “on” another element, it can be directly on the other element or an intervening element may also be present. It will also be understood that, when an element such as a layer, film, region or substrate is referred to as being “under” another element, it can be directly under the other element or an intervening element may also be present.

Unless the context clearly indicates otherwise, all numbers, figures and/or expressions that represent ingredients, reaction conditions, polymer compositions and amounts of mixtures used in the specification are approximations that reflect various uncertainties of measurement occurring inherently in obtaining these figures among other things. For this reason, it should be understood that, in all cases, the term “about” should modify all numbers, figures and/or expressions. Further, unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

In addition, when numeric ranges are disclosed in the description, these ranges are continuous and include all numbers from the minimum to the maximum including the maximum within the range unless otherwise defined. Furthermore, when the range refers to an integer, it includes all integers from the minimum to the maximum including the maximum within the range, unless otherwise defined.

It should be understood that, in the specification, when the range refers to a parameter, the parameter encompasses all figures including end points disclosed within the range. For example, the range of “5 to 10” includes figures of 5, 6, 7, 8, 9, and 10, as well as arbitrary sub-ranges such as ranges of 6 to 10, 7 to 10, 6 to 9, and 7 to 9, and any figures, such as 5.5, 6.5, 7.5, 5.5 to 8.5 and 6.5 to 9, between appropriate integers that fall within the range. In addition, for example, the range of “10% to 30%” encompasses all integers that include figures such as 10%, 11%, 12% and 13%, as well as 30%, and any sub-ranges of 10% to 15%, 12% to 18%, or 20% to 30%, as well as any figures, such as 10.5%, 15.5% and 25.5%, between appropriate integers that fall within the range.

### Secondary Battery Positive Electrode

Provided is, inter alia, a secondary battery positive electrode that may be used to manufacture a secondary battery, however, it is not particularly restricted as long as it is possible to increase the output and capacity of a secondary battery including the same.

A secondary battery positive electrode may include a ferroelectric, a positive electrode active material, a binder, and a conductive agent. The positive electrode may suitably include an amount of about 1 to 10 wt % of a ferroelectric, an amount of about 80 to 95 wt % of a positive electrode active material, an amount of about 1 to 10 wt % of a binder, and an amount of about 1 to 10 wt % of a conductive agent, based on the total weight of the positive electrode.

### (1) Ferroelectric Component

A ferroelectric component is not particularly restricted as long as it is possible to equalize the distribution of electric charge on the surface of the positive electrode active material and to enable rapid movement of lithium ions through polarization, thereby inhibiting precipitation of metal ions.

The ferroelectric component as used herein may be a known normal ferroelectric component, and may include, for example, one or more selected from the group consisting of BaTiO₃, (Ba, Sr)TiO₃, PbTiO₃, LiNbO₃, Pb(Zr, Ti)O₃, SrBi₂Ti₂O₉, and amorphous V₂O₅. The ferroelectric component is characterized in that the relative permittivity and crystal structure of the ferroelectric component are changed depending on kind and temperature of an element that is substituted and in that the extent to which the ferroelectric component exhibits dielectricity is changed. Particularly, when the ferroelectric component has a double perovskite structure, the ferroelectric component may have a positive thermal coefficient (PTC) property in which resistance increases at a predetermined temperature or higher. As such, the ferroelectricity may be exhibited within a desired temperature range, and in that the ferroelectric component can be utilized in a battery in order to improve safety and ability to withstand low temperature of the battery. Meanwhile, a secondary battery positive electrode manufactured by adding such a ferroelectric material is characterized in that the ferroelectricity of the secondary battery positive electrode can be maintained within a desired temperature range and in that Curie temperature Tc of the secondary battery positive electrode can be adjusted depending on an element that is added such that the secondary battery positive electrode can be operated within a specific temperature range or without limitation of temperature that is used. Consequently, the ferroelectric component preferably may include BaTiO₃, which efficiently inhibits the decomposition reaction of an electrolytic solution occurring due to precipitation of metal ions. As such, it is possible to inhibit a decrease in performance of a battery or a decrease in residual capacity and recovery capacity of the battery at the time of high-temperature retention and to improve safety due to an increase in resistance at a predetermined temperature or higher, although not limited as including a specific ingredient.

The particle size of the ferroelectric component may be about 100 nm to 5 μm, particularly about 1 to 3 μm. When the particle size of the ferroelectric component is less than about 100 nm, the permittivity of the ferroelectric component may be reduced. When the particle size of the ferroelectric component is greater than about 5 μm, contact area may be reduced, and slurry quality may be deteriorated.

The content of the ferroelectric component may be about 1 to 10 wt % based on 100 wt % of the positive electrode. When the content of the ferroelectric component is less than about 1 wt %, the permittivity of the ferroelectric component may not have a sufficient effect. When the content of the ferroelectric component is greater than about 10 wt %, the percentage of the active material may be reduced, and thus the capacity of the battery may be reduced.

Consequently, the secondary battery positive electrode is characterized in that the secondary battery positive electrode includes a ferroelectric, such that it is possible to equalize the distribution of electric charge on the surface of the positive electrode active material and to enable rapid movement of lithium ions through polarization, thereby inhibiting precipitation of metal ions. As such, it is possible to efficiently inhibit the decomposition reaction of the electrolytic solution occurring due to precipitation of metal ions. Moreover, it is possible to inhibit a decrease in performance of a battery or a decrease in residual capacity and recovery capacity of the battery at the time of high-temperature retention and to improve safety due to an increase in resistance at a predetermined temperature or higher, such that it is possible to improve the output performance of a secondary battery including the same while increasing the capacity at a high charge rate of the secondary battery.

### (2) Positive Electrode Active Material

A positive electrode active material is not particularly restricted as long as it is possible to occlude and discharge lithium ions.

The positive electrode active material may include normal positive electrode active material that can be used in the present invention. For example, the positive electrode active material may include a layered compound, such as lithium cobalt oxide (LiCoO₂), or lithium nickel oxide (LiNiO₂), or a compound substituted with one or more transition metals; lithium manganese oxide represented by the chemical formula Li₁₊ₓMn₂₋ₓO₄ (where x=0 to 0.33) or lithium manganese oxide, such as LiMnO₃, LiMn₂O₃, or LiMnO₂; lithium copper oxide (Li₂CuO₂); vanadium oxide, such as LiV₃O₈, LiFe₃O₄, V₂O₅, or Cu₂V₂O₇; Ni-sited lithium nickel oxide represented by the chemical formula LiNi₁₋ₓMₓO₂ (where M=Co, Mn, Al, Cu, Fe, Mg, B, or Ga, and x=0.01 to 0.3); lithium manganese composite oxide represented by the chemical formula LiMn₂₋ₓMₓO₂ (where M=Co, Ni, Fe, Cr, Zn, or Ta, and x=0.01 to 0.1) or the chemical formula Li₂Mn₃MO₈ (where M=Fe, Co, Ni, Cu, or Zn); LiMn₂O₄ in which a portion of Li in the chemical formula is replaced by alkaline earth metal ions; a disulfide compound; or Fe₂(MoO₄)₃. Thereamong, the positive electrode active material may be LiMn₂O₄, LiCoO₂, LiNiO₂, LiMnCoNiO₂, LiNiCoMnO₂, or LiFeO₄. The positive electrode active material preferably may include a mixture of LiNiCoMnO₂ or LiNiCoMnO₂ and at least one other material based on the rate, particle size, or property thereof, although not limited as including a specific ingredient.

The content of the positive electrode active material according to the present invention may be about 80 to 95 wt % based on 100 wt % of the positive electrode. When the content of the positive electrode active material is less than about 80 wt %, battery capacity may be reduced. When the content of the positive electrode active material is greater than about 95 wt %, electrode stability may be reduced due to a decrease in adhesiveness, or capacity may be reduced due to a decrease in conductivity.

### (3) Binder

A binder is not particularly restricted as long as it is possible to assist in binding between the active material and the conductive agent and in binding with a current collector.

The binder may include one or more selected from the group consisting of polyvinylidene fluoride, polyvinyl alcohol, carboxymethyl cellulose (CMC), starch, hydroxypropyl cellulose, regenerated cellulose, polyvinyl pyrrolidone, tetrafluoroethylene, polyethylene, polypropylene, ethylene-propylene-diene terpolymer (EPDM), sulfonated EPDM, styrene butadiene rubber, fluoro rubber, and various copolymers. The binder may preferably include polyvinylidene fluoride or a mixture of polyvinylidene fluoride and may further include at least one other material, although not limited as including a specific ingredient.

The content of the binder may be about 2 to 5 wt % based on 100 wt % of the positive electrode. When the content of the binder is less than about 2 wt %, electrode adhesiveness may be reduced, the electrode may be unstable and thus the lifespan thereof may be reduced. When the content of the binder is greater than about 5 wt %, the amount of the active material may be reduced, and capacity may be reduced.

### (4) Conductive Agent

A conductive agent is not particularly restricted as long as the conductive agent exhibits high conductivity without inducing any chemical change in a battery to which the conductive agent is applied.

The conductive agent may include normal conductive agent that can be used in the present invention. The conductive agent may include, for example, one or more selected from the group consisting of graphite, such as natural graphite or artificial graphite; carbon black, such as carbon black, acetylene black, Ketjen black, channel black, furnace black, lamp black, or summer black; conductive fiber, such as carbon fiber or metallic fiber; metallic powder, such as carbon fluoride powder, aluminum powder, or nickel powder; conductive whisker, such as zinc oxide or potassium titanate; a conductive metal oxide, such as titanium oxide; and a polyphenylene derivative. The conductive agent may preferably include a mixture of carbon black and graphite, although not limited as including a specific ingredient.

The content of the conductive agent may be about 3 to 10 wt % based on 100 wt % of the positive electrode. When the content of the conductive agent is less than about 3 wt %, a conduction path may be reduced, and capacity may be reduced. When the content of the conductive agent is greater than about 10 wt %, the content of the active material may be reduced, and capacity may be reduced.

In addition, a filler, which is an ingredient that inhibits the expansion of the positive electrode, may be optionally used. The filler is not particularly restricted as long as the filler does not cause chemical changes in a battery to which the filler is applied and is made of a fibrous material as a known normal filler that can be used in the present invention. For example, an olefin polymer, such as polyethylene or polypropylene; or a fibrous material, such as glass fiber or carbon fiber may be used.

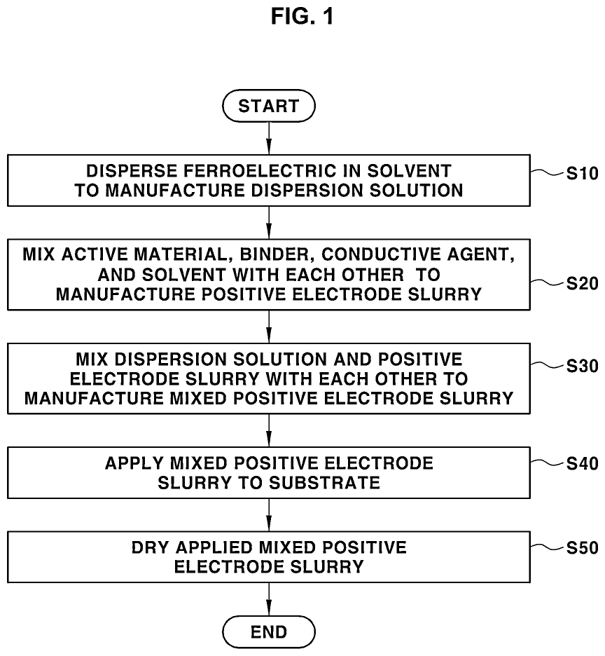

FIG. 1 shows an exemplary a method of manufacturing a secondary battery positive electrode according to an exemplary embodiment of the present invention. The method includes a step (S10) of dispersing a ferroelectric component in a first solvent to prepare an admixture, a step (S20) of mixing an active material, a binder, a conductive agent, and a second solvent with each other to manufacture a positive electrode slurry, a step (S30) of mixing the admixture and the positive electrode slurry with each other to manufacture a coating slurry, a step (S40) of applying the coating slurry to a substrate, and a step (S50) of drying the applied coating slurry.

The first solvent and the second solvent may be the same or different.

The step (S10) of manufacturing an admixture may include a step of mixing a ferroelectric component and a solvent with each other such that the ferroelectric component is dispersed in the solvent, the admixture being mixed with a positive electrode slurry in a subsequent step. The ferroelectric component may be identical to the ferroelectric component described above. The solvent may include normal solvent that can be used in the present invention, and may include, for example, N-methylpyrrolidone (NMP), dimethylformamide, dimethylacetamide, N,N-dimethylamino propylamine, ethylene oxide, or tetrahydrofuran. The solvent may preferably include N-methylpyrrolidone, although not limited as including a specific ingredient. The admixture may be manufactured through ultrasonic dispersion for about 7 to 15 minutes. When the dispersion time is less than about 7 minutes, dispersion is not sufficiently performed, whereby the addition effect is limited. When the dispersion time is greater than about 15 minutes, the solvent may be evaporated by heat that is generated, or manufacturing time is lengthened.

The step (S20) of manufacturing a positive electrode slurry may include a step of mixing an active material, a binder, a conductive agent, and a second solvent with each other to manufacture a positive electrode slurry. The active material, the binder, and the conductive agent may be identical to the active material, the binder, and the conductive agent described above. In addition, the second solvent may include or be the first solvent described above. The coating slurry may be manufactured through mixing for about 7 to 15 minutes. When the mixing time is less than about 7 minutes, dispersion may not be sufficiently performed and an electrode may not be homogenized, whereby capacity is reduced and thus the lifespan thereof is reduced. When the mixing time is greater than about 15 minutes, manufacturing time may be lengthened.

The step (S30) of manufacturing a coating slurry and the step (S40) of applying the coating slurry to a substrate may include steps of mixing the prepared admixture and the positive electrode slurry with each other to manufacture a coating slurry and applying the coating slurry to a substrate. The admixture and the positive electrode slurry may be identical to the admixture and the positive electrode slurry described above. The substrate may include normal substrate, for example, aluminum foil, nickel foil, copper foil, or carbon-coated foil as a current collector. The substrate may preferably include aluminum foil, although not limited to a specific kind. In addition, the method of applying the coating slurry to the substrate may include normal application method that can be used in the present invention, and, for example, a doctor blade method, a die casting method, a comma coating method, or a screen printing method may be used. The doctor blade method or the die casting method may preferably be used, although the method is not limited to a specific method.

The drying step (S50) may include a step of drying the applied coating slurry to manufacture a secondary battery positive electrode. Drying may be performed at a temperature of about 75 to 95° C. When the drying temperature is less than about 75° C., solvent may remain. When the drying temperature is greater than about 95° C., the electrode-constituting materials may be denatured.

Consequently, the method of manufacturing the secondary battery positive electrode is characterized in that a low-priced material is used as the ferroelectric, and process efficiency thereof may be improved. Moreover, it is possible to equalize the distribution of electric charge on the surface of the positive electrode active material and to enable rapid movement of lithium ions through polarization, thereby inhibiting precipitation of metal ions, and it is possible to improve the output performance of a secondary battery including the same while increasing the capacity at a high charge rate of the secondary battery.

### EXAMPLE

Hereinafter, the present invention will be described in more detail with reference to concrete examples. However, the following examples are merely an illustration to assist in understanding the present invention, and the present invention is not limited by the following examples.

### Example 1—Manufacture of Secondary Battery Including Secondary Battery Positive Electrode

A secondary battery positive electrode was manufactured as follows. Specifically, (S10) 10 g of BaTiO₃ having a particle size of 0.1 μm, as a ferroelectric, was mixed with 90 g of NMP, as a solvent, and was dispersed in the solvent using ultrasonic waves for 10 minutes to manufacture an admixture. Subsequently, (S20) 62.5 g of NMC, as an active material, 4.7 g of PVdF, as a binder, 2.7 g of carbon black and graphite, as a conductive agent, and 48 g of NMP, as a solvent, were mixed with each other for 25 minutes to manufacture a positive electrode slurry. Subsequently, (S30 and S40) the manufactured admixture and the manufactured positive electrode slurry were mixed with each other to manufacture a coating slurry, and the coating slurry was applied to aluminum, as a substrate, using a doctor blade method. Subsequently, (S50) the applied coating slurry was dried at a temperature of 90° C. for 12 hours to manufacture a positive electrode. At this time, the content of BaTiO₃, as the ferroelectric, was 1 wt % based on 100 wt % of the positive electrode.

Subsequently, a secondary battery was finally manufactured using a 2032 coin cell manufacturing method.

### Example 2—Manufacture of Secondary Battery Including Secondary Battery Positive Electrode

A secondary battery was manufactured in the same manner as in Example 1 except that the positive electrode was manufactured under the condition that the content of BaTiO₃, as the ferroelectric, was 5 wt % based on 100 wt % of the positive electrode, compared to Example 1.

### Example 3—Manufacture of Secondary Battery Including Secondary Battery Positive Electrode

A secondary battery was manufactured in the same manner as in Example 1 except that the positive electrode was manufactured using BaTiO₃ having a particle size of 2 μm as the ferroelectric, compared to Example 1.

### Example 4—Manufacture of Secondary Battery Including Secondary Battery Positive Electrode

A secondary battery was manufactured in the same manner as in Example 1 except that the positive electrode was manufactured using BaTiO₃ having a particle size of 2 μm as the ferroelectric, compared to Example 2.

### Comparative Example 1—Manufacture of Secondary Battery Including Secondary Battery Positive Electrode

A secondary battery was manufactured in the same manner as in Example 1 except that the positive electrode was manufactured while including no ferroelectric, compared to Example 1.

### Comparative Example 2—Manufacture of Secondary Battery Including Secondary Battery Positive Electrode

A secondary battery was manufactured in the same manner as in Example 1 except that the positive electrode was manufactured using BaTiO₃ having a particle size of 100 nm as the ferroelectric, compared to Example 1.

### Experimental Example 1—Comparison in Capacity Between Secondary Batteries Based on Content of Ferroelectric

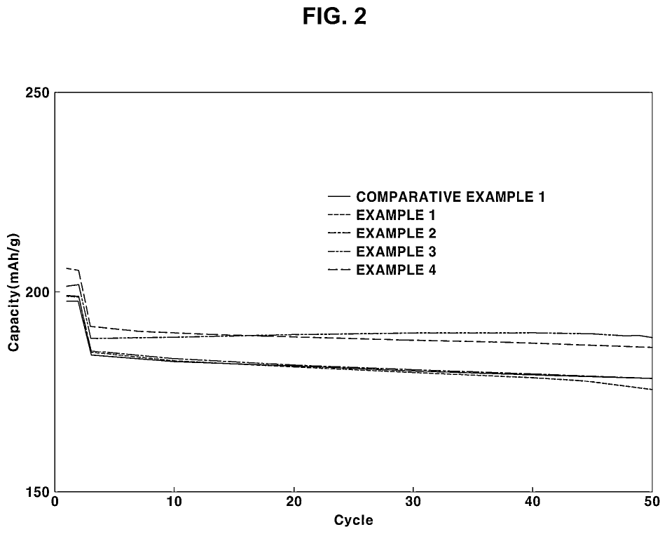

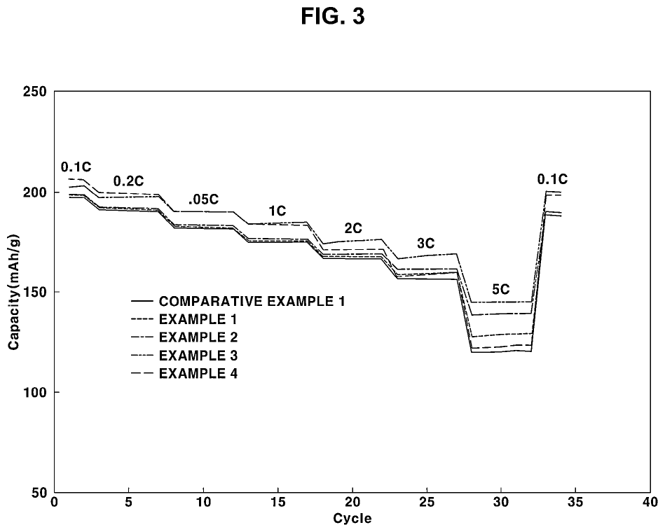

The secondary batteries manufactured according to Examples 1 to 4 and the secondary battery manufactured according to Comparative Example 1 were compared in capacity with each other, and the results are shown in FIGS. 2 and 3.

As shown in FIGS. 2 and 3, it can be seen that the capacities of the secondary batteries manufactured according to Examples 1 to 4, in each of which the ferroelectric component was included, were higher by 120 to 180 mAh/g at high charge rates of 5C, 3C, and 2C than the capacity of the secondary battery manufactured according to Comparative Example 1, in which no ferroelectric component was included.

### Experimental Example 2—XRD Analysis of Secondary Batteries Based on Particle Size of Ferroelectric

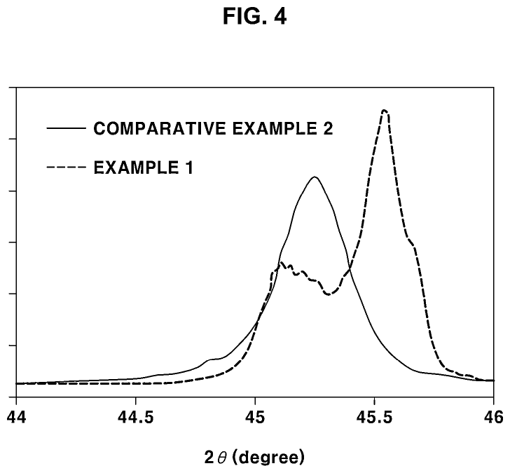

The secondary battery manufactured according to Example 1 and the secondary battery manufactured according to Comparative Example 2 were compared with each other through XRD analysis, and the results are shown in FIG. 4.

As shown in FIG. 4, it can be seen that the secondary battery manufactured according to Example 1, in which the ferroelectric component having a particle size of 2 μm was included, had higher ferroelectricity than the secondary battery manufactured according to Comparative Example 2, in which the ferroelectric component having a particle size of 100 nm was included, since (00a) and (a00) peaks were separated from each other, whereby the ferroelectric component in Example 1 was capable of being appropriately used as the ferroelectric component according to the present invention.

Consequently, the secondary battery positive electrode according to various exemplary embodiments of the present invention is characterized in that 1 to 10 wt % of the ferroelectric component having a particle size of 100 nm to 2 μm is included in the positive electrode, such that it is possible to equalize the distribution of electric charge on the surface of the positive electrode active material and to enable rapid movement of lithium ions through polarization, thereby inhibiting precipitation of metal ions. Furthermore, it is possible to efficiently inhibit the decomposition reaction of the electrolytic solution occurring due to precipitation of metal ions, and it is possible to inhibit a decrease in performance of a battery or a decrease in residual capacity and recovery capacity of the battery at the time of high-temperature retention and to improve safety due to an increase in resistance at a predetermined temperature or higher. Moreover, it is possible to improve the output performance of a secondary battery including the same while increasing the capacity at a high charge rate of the secondary battery.

According to various exemplary embodiments of the present invention, the method of manufacturing the secondary battery positive electrode may use a low-priced material as the ferroelectric, so high process efficiency may be obtained. In addition, the secondary battery positive electrode may include the ferroelectric, such that it is possible to improve the output performance of a secondary battery including the same while increasing the capacity at a high charge rate of the secondary battery.

The effects of the present invention are not limited to those mentioned above. It should be understood that the effects of the present invention include all effects that can be inferred from the foregoing description of the present invention.

The invention has been described in detail with reference to exemplary embodiments thereof. However, it will be appreciated by those skilled in the art that changes may be made in these embodiments without departing from the principles and spirit of the invention, the scope of which is defined in the appended claims and their equivalents.

1.-4. (canceled)

5. A method of manufacturing a secondary battery positive electrode, comprising:
preparing an admixture comprising a ferroelectric component and a first solvent;
preparing a positive electrode slurry comprising an active material, a binder, a conductive agent, and a second solvent;
preparing a coating slurry comprising the admixture and the positive electrode slurry;
applying the coating slurry to a substrate; and
drying the applied coating slurry.

6. The method according to claim 5, wherein the admixture is prepared by performing ultrasonic dispersion for 7 to 15 minutes.

7. The method according to claim 5, wherein the coating slurry is manufactured by mixing the admixture and the positive electrode slurry for 7 to 15 minutes.

8. The method according to claim 5, wherein the drying is performed at a temperature of 75 to 95° C.

9. (canceled)

10. The method according to claim 5, wherein the secondary battery positive electrode manufactured by the method comprising the ferroelectric component, the positive electrode active material, the binder, and the conductive agent,
wherein the ferroelectric component has a particle size of 100 nm to 5 μm.

11. The method according to claim 10, wherein a content of the ferroelectric component is 1 to 10 wt % based on 100 wt % of the positive electrode.

12. The method according to claim 10, wherein the ferroelectric component comprises one or more selected from the group consisting of BaTiO₃, (Ba, Sr)TiO₃, PbTiO₃, LiNbO₃, Pb(Zr, Ti)O₃, SrBi₂Ti₂O₉, and amorphous V₂O₅.

13. The method according to claim 10, wherein the positive electrode active material comprises one or more selected from the group consisting of LiMn₂O₄, LiCoO₂, LiNiO₂, LiNiCoMnO₂, LiFeO₄, and LiMnCoNi₃O₂.

14. A secondary battery comprising the positive electrode according to claim 10, wherein the secondary battery has a capacity of 120 to 180 mAh/g at 2C to 5C.
